(19) United States
(12) Patent Application Publication
(10) Pub. No.: US 2014/0122164 A1
(43) Pub. Date: May 1, 2014

(54) System and method for analyzing commuting metrics

(71) Applicant: SWeRP, Inc., Lafayette, CO (US)

(72) Inventor: Bonnie Lucara, Lafayette, CO (US)

(73) Assignee: SWERP, INC., Lafayette, CO (US)

(21) Appl. No.: 14/065,213

(22) Filed: Oct. 28, 2013

Related U.S. Application Data
(60) Provisional application No. 61/719,458, filed on Oct. 28, 2012.

(51) Int. Cl. G06Q 10/06; G06Q 10/10

(52) U.S. Cl. CPC G06Q 10/0635; G06Q 10/105
USPC 705/7.28

(57) ABSTRACT

A system and method for analyzing commuting metrics. One exemplary embodiment includes a method that includes receiving, via a computer interface, location data for a set of locations associated with an entity, the location data including physical location data, the computer interface selected from at least one of a user interface or network communications interface; receiving commuter data for a set of commuters, the commuter data for each commuter from the set of commuters including commute start location data; determining a set of values of a commuting metric, each value from the set of values of the commuting metric being based on one of the physical location data and one of the commute start location data; and generating an electronic file including at least one of the set of values of the commuting metric.

### CLAIM OF PRIORITY

The present application claims priority to commonly owned and assigned application No. 61/719,458, entitled Method and System for Calculating Commuting Metrics for Current and Future Employees and filed Oct. 28, 2012, the disclosure of which is incorporated herein by reference in its entirety for all purposes.

### FIELD

One or more disclosed embodiments relate to analyzing commuting metrics. In particular, but not by way of limitation, disclosed embodiments relate to systems and methods for managing, analyzing, optimizing, and reporting commuting metrics for commuters; businesses; organizations; local municipalities; and state, regional, and local agencies.

### BACKGROUND

A direct correlation exists between employee turnover and employee commutes. That is, employees are more likely to change employers as the time, distance, and cost of a commute rise. Stress resulting from a commute can also contribute to dissatisfaction with a job, and stress and long commute times can contribute to lost productivity. All of this raises the likelihood that employees will leave their jobs. Businesses are then saddled with higher operating costs from increased employee turnover. Yet businesses currently have little control or direct influence over commuting problems and their solutions.

Likewise, commuters typically have little or no influence over their commute. Most are left with commuting to the same location and trying to cope with existing commuting problems. Others can try carpooling, vanpooling, or using public transportation or can telecommute. The former option comes with a new host of commuting issues (longer commute times, outage and maintenance problems, changes in schedule, problems finding suitable pools, and the like) while failing to alleviate major commuting issues like commuting time, commuting distance, etc and ignoring many individuals' affinity for single-passenger, personal-vehicle driving. And the latter option is oftentimes unavailable and, when it is, can create new issues related to overly distributed workforces.

Transportation agencies conduct extensive and expensive planning and must typically struggle to keep multiple projects from multiple different agencies on track to the extent they attempt to do so at all. Moreover, transportation agencies also struggle to keep plans for future works up to date with current commuting trends. They expend massive taxpayer funds to conduct the studies for those projects and, to the extent, any information from the private sector is shared, no mechanism exists for agencies to easily acquire any existing information.

Carpooling, high-occupancy vehicle (HOV) lanes, public transportation, and the like, collectively commute trip reduction efforts, have historically been tried by commuters and government agencies alike to solve problems associated with commuting. Carpooling, however, still results in long commute times, sometimes even longer than without carpooling because those sharing rides must travel longer or wait for others so that a ride can be shared. HOV lanes, to the extent they are effective, can have an impact only during rush hour traffic. Similarly, public transportation, to the extent an individual consumer is able to use it, also too often fails to reduce commute times because schedules and/or routes do not meet the needs of a commuter—that is, a commuter may have to transfer an unacceptable number of times, a commuter may have to wait at transfer stations, and the like. Furthermore, public transportation can carry with it high costs for tickets or passes, parking at stations, and the like. And again, to the extent public transportation is effective at reducing commuting times, it is effective only during rush hour.

### SUMMARY

Example embodiments are shown in the drawings and are summarized below. These and other embodiments are more fully described in the Detailed Description section. It is to be understood, however, that there is no intention to be limited to the forms described in this Summary or in the Detailed Description. One skilled in the art can recognize that there are numerous modifications, equivalents and alternative constructions that fall within the spirit and scope of the inventions as expressed in the claims.

One or more disclosed embodiments can provide a system and method for analyzing commuting metrics. One example embodiment includes a method that includes receiving, via a computer interface, location data for a set of locations associated with an entity, the location data including physical location data, the computer interface selected from at least one of a user interface or network communications interface; receiving commuter data for a set of commuters, the commuter data for each commuter from the set of commuters including commute start location data; determining a set of values of a commuting metric, each value from the set of values of the commuting metric being based on one of the physical location data and one of the commute start location data; and generating an electronic file including at least one of the set of values of the commuting metric.

Another example embodiment includes a system including a server having a processor, a memory, and network communications interface, the server configured to: receive, via the network communications interface, location data for a set of locations associated with an entity, the location data including physical location data; receive commuter data for a set of commuters, the data for each of the set of commuters including commute start location data; determine a set of values of a commuting metric, each of the set of values of the commuting metric being based on one of the physical location data and one of the commute start location data; and generate an electronic file including at least one of the set of values of the commuting metric.

Another example embodiment includes a non-transitory processor-readable medium including instructions for: receiving, via a computer interface, location data for a set of locations associated with an entity, the location data including physical location data, the computer interface selected from one of a user interface or network communications interface; receiving commuter data for a set of commuters, the commuter data for each commuter from the set of commuters including commute start location data; determining a set of values of a commuting metric, each value from the set of values of the commuting metric being based on one of the physical location data and one of the commute start location data; and generating an electronic file including at least one of the set of values of the commuting metric.

One or more disclosed embodiments are related to data processing systems, methods and computer program products for a company to calculate commuting metrics of one or more employees and to determine if such commuting metrics can be improved if one or more employees are transferred to a different job location operated by the first company and or a different job location operated by a second company. One or more disclosed embodiments can determine the placement of employees in commute-optimal locations and/or determine employees that should be swapped from one employer location to another to increase employee retention. A commuting metric can include commuting time, commuting distance, commuting expense, emissions generated (e.g., amount of carbon monoxide, nitrogen oxides, sulfur oxide, volatile compounds, hydrocarbons, particulates emitted or some other emission), fuel consumption (e.g., amount of fuel consumed, type of fuel consumed such as gas, electricity, coal, etc.), fuel cost, and the like for a given commute.

As there is a direct correlation between employee turnover and their commute, reducing the time, distance, cost, and or stress an employee experiences, the less likely they are to leave their position. Further, given the costs associated with employee turnover, improving the commute of employees can significantly lower a company's operational costs.

One or more embodiments provide businesses the unique ability to retain experienced employees, while reducing the need (and expense) to recruit, hire and train replacement workers. In using one or more embodiments, companies can minimize an employee's commuting time and expense which, in turn, provides a greater quality of life for the employee. In addition, the use of one or more embodiments improves employee productivity, quality of service, morale, and company loyalty, any of which can improve revenue and or lower expenses. Moreover, employees can gain better insight into their commuting options and the resulting benefits while employers can enhance their brand image and marketability. Additionally, transportation agencies can gather more current and finely-grained data to either augment or replace expensive, expansive, and slow-moving studies or to assist employers in new outreach programs.

One or more embodiments analyze a workforce of one or more companies by position and job location in order to identify opportunities for employees to be transferred, for example, to job locations closest to their homes. By using the skills needed for a given position, such commuting improvement may be at a job location operated by the existing company or at a job location operated by a separate company.

One or more embodiments generate and/or analyze “swap queues” of employees eligible for or interested in transferring to other locations by combining commuting metric analysis with human resources data or human resources data analysis. Furthermore, one or more embodiments can track historical commuting data along with human resources data to analyze employee turnover history and to analyze likely turnover, including finding employees more likely to leave. In such embodiments, the same or different commuting metrics can be used in the analysis.

### BRIEF DESCRIPTION OF THE DRAWINGS

FIG. 1 illustrates a schematic block diagram of a specially-programmed computer that can implement one or more computer system components in accordance with some embodiments.

FIG. 2 illustrates a schematic block diagram of a system that allows for the analysis of commuting metrics for use by commuters, businesses, and agencies in accordance with some embodiments.

FIG. 3 illustrates a schematic block diagram of a system that allows for the analysis of commuting metrics for use by commuters, businesses, and agencies that includes multiple data stores in accordance with some embodiments.

FIG. 4 illustrates a schematic block diagram of a system that allows for the analysis of commuting metrics for use by commuters, businesses, and agencies that includes transit data in accordance with some embodiments.

FIGS. 5-11 illustrate methods for analyzing commuting metrics in accordance with some embodiments.

### DETAILED DESCRIPTION

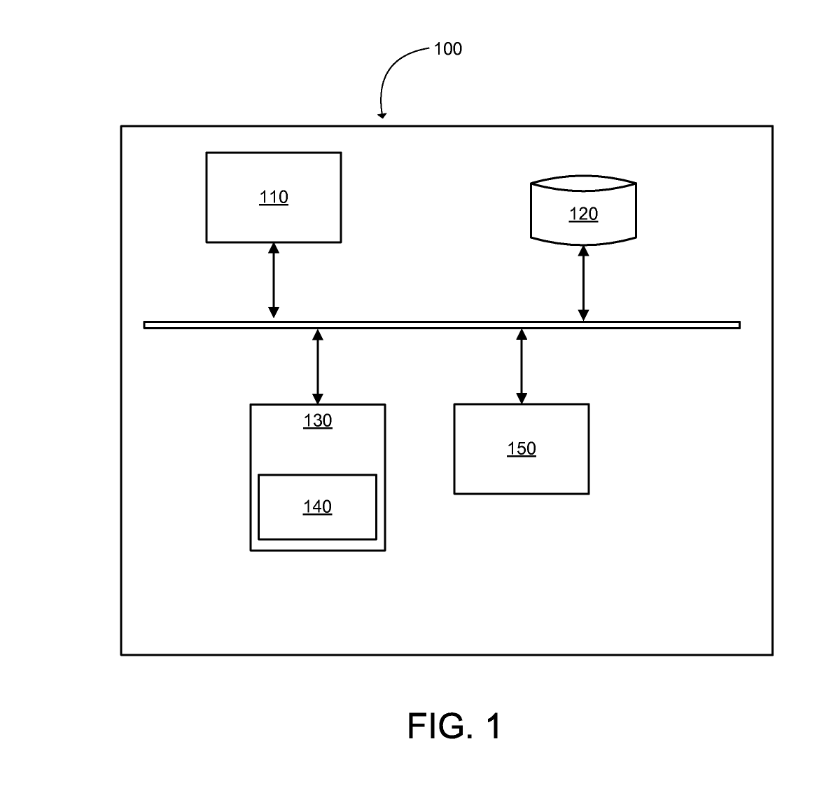

In referring to the drawings, like or similar elements are designated with identical reference numerals throughout the several views. FIG. 1 illustrates an embodiment of specially-programmed computer 100 that can implement one or more of the foregoing components in accordance with some embodiments. Such a computer 100 can include a network communications interface 110, storage medium 120, memory 130, program instructions 140, and processor 150. Program instructions 140 can be used to implement one or more of the components or portions of components of the system 100. Moreover, in some embodiments, additional hardware components of computer 100 can be included that implement one or more of the components or portions of components of the system 100. The storage medium 120 can be a hard disk drive, but this is certainly not required, and other storage media can be used with disclosed embodiments. In addition, the storage medium 120, which is depicted for convenience as a single storage device, may be realized by multiple (e.g., distributed) storage devices. Moreover, some embodiments can include one or more storage devices external to computer 100.

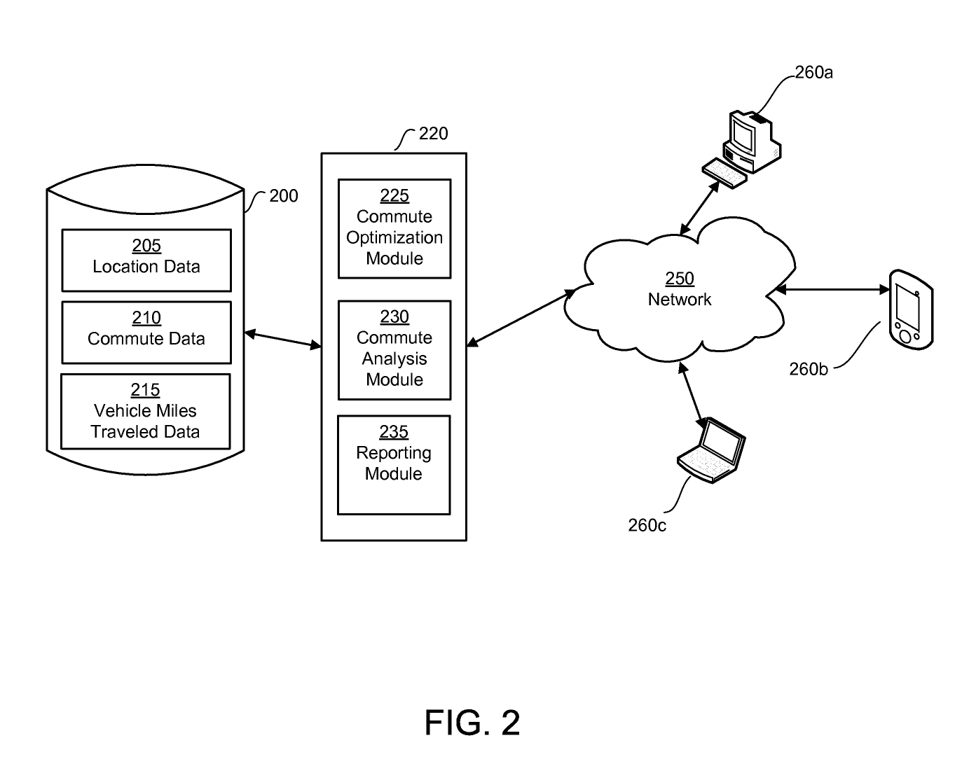

Referring now to FIG. 2, an embodiment is shown in which server 220 hosts a commute optimization module 225, a commute analysis module 230, and a reporting module 235; and data store 200 hosts location data 205, commute data 210, and vehicle miles traveled data 215. Location data 205 can include coordinate information, digital map data, address data, and the like. In some embodiments, location data corresponding to an entity (e.g., employer, business, etc.) can include information related to the entity's locations (e.g., store; office; existing, planned, and potential locations, etc.) such as physical addresses, coordinates, and the like. Furthermore, location data corresponding to an entity can include employee position (i.e., job opening) information corresponding to an entity location, skill and/or experience requirement data corresponding to the employee position information, the number of locations, number of commuters (e.g., number of employees for an employer) for each location or the entity as a whole, and the like.

Commute data 210 can include physical address data (e.g., residence location information or other commute start location data), digital route data, commute route history data, including data corresponding to routes taken and commute time over the route. Commute data 210 also can include data for an individual commuter, including name and other identifying information. Further, commute data 210 can include data related to employment, such as shift information (e.g., type of shift, shift start time, shift end time, shift identifier, etc.); whether an employee is full time, part time, employed, or unemployed; start date of employment, end date of employment; and the like. In this way, some embodiments can be used to analyze employee turn over information or predict employee turn over. Some embodiments can analyze historical employee turnover and commuting metrics for employees who have left their jobs and employees who have stayed at their jobs and determine whether and which current employees are likely to leave based on matching commuting metrics. For example, employees at particular employers or employer locations whose commuting metrics for miles traveled, time traveled, number of legs, commute cost, and the like reach a predetermined value or match commuting metric values of other similarly situated historical employees can be determined to be “at risk” for turn over.

In some embodiments, commute data 210 can include personal information corresponding to a commuter, including commuter name, unique commuter identifier, current job location, current position, position description, commuter skill and/or experience information, and the like. In some embodiments, commute data 210 can include modes of transportation information corresponding to a commuter, for example, car, bus, rail, plan, bicycle, pedestrian, and the like. Commute data 210 can also include mode of transportation history, current mode of transportation, and available mode of transportation corresponding to a commuter. In some embodiments, commute data 210 can include data related to human resource information. For example, an employer may track whether an employee would be a good match for transfer to another location based on performance review feedback, type of positions held, and the like. In this way, an employer can implement a “swap queue” based on commuting metric values, eligibility information, and the like, rather than just on commuting metric values.

Vehicle miles traveled data 215 can include commute distance data corresponding to a particular commuter or commuter's vehicle as well as identifying data for the commuter and/or the vehicle, including social security number or taxpayer ID, name, address, VIN, make, model, estimate fuel economy, actual fuel economy, actual fuel usage, and the like.

In some embodiments, location data, commute data, and vehicle miles traveled data each can be further separated or combined and/or distributed across a network and/or different locations. Data store 200 and/or other data stores can be hosted at server 220. In some instances, server 220 and/or data store 200 can be hosted, maintained, operated, or controlled by a business or entity using the embodiment. In other instances, server 220 and/or data store 200 can be hosted, maintained, operated, or controlled by another entity and/or at a different physical location that the entity using the system. Further, in some instances, server 220 and/or other data stores can be provided on employer premises.

Server 220 can communicate with data store 200 through an internal or external network, including network 250. It should be appreciated that commute optimization module 225, commute analysis module 230, reporting module 235, or some combination thereof can communicate with data store 200, network 250, and other internal or external components. Server 220 can receive location data and/or commute data to determine commuting metric values and can receive data from some other data source through network 250 to determining a commuting metric value.

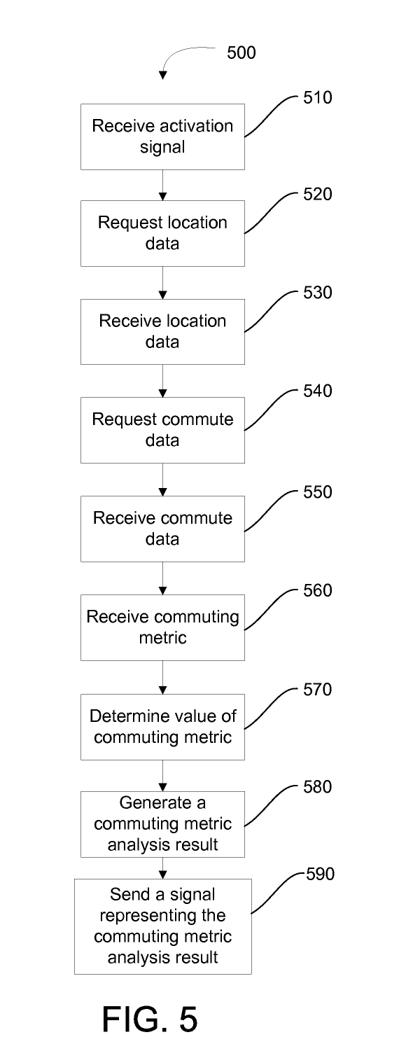

Commute optimization module 225 can determine a commuting metric value for a commuter and a location in accordance with embodiments described at FIGS. 5-11. In some instances, commute optimization module 225 can determine a current commuting metric value, such as a commute time, for a commuter using location data 205 and commute data 210. Commute optimization module 225 can also determine a potential commuting metric value for a commuter. For example, an employer can have an open position at one location and employees at one or more other locations. Commute optimization module 225 can match employees or potential employees based on skill and/or experience data corresponding to the commuter and/or the position and determine a commute time for employees that match. Commute optimization module 225 can also determine the current and potential commuting metric value for a single employee. In this way, employers can determine which employee or employees to offer the position or simply which employee or employees will have the best commute according to commute time.

The value of other commuting metrics can be determined as well. For example, commute data 210 can include the type of car a commuter drives along with the fuel economy of the car or commute optimization module 225 can receive fuel economy statistics for the car and can determine a fuel usage commuting metric value. A fuel usage commuting metric value or other commuting metric values can be further based on other data, including the commute distance, any possible planned roadwork or maintenance, changes in the route, commute history, traffic profile for the route, and the like. For example, commute optimization module 225 can receive fuel cost data and determine commute cost metric.

Commute optimization module 225 can also weight commuting metrics using predetermined weighting factors or selectable weighting factors, determine a commuting metric value derived from other commuting metric values, determine a commuting metric value from an aggregation of other commuting metric values, and the like. Moreover, commute optimization module 225 can determine multiple commuting metric values.

In some embodiments, a commuting metric derived or aggregated from other commuting metrics can indicate: a location at which an employee should work; a commuter-location (e.g., employee-employer location) correlation; whether an opening position exists at a location the ranking of employer locations at which an employee should work; on what days an employee should work at a particular location; which of two or more employees has the optimal commute to a particular location (e.g., if a position opens at an employer location to be filled by employees at other locations); the optimal commute or ranking of commutes of two or more employees or potential employees for one or more employer locations; and the like. A commuting metric can also indicate a return based on a commuting change and the commuting metric values before and after a commuting change or other comparisons of earlier and later commuting metric values or actual and potential commuting metric values. Further, in some embodiments, one or more commuting metrics can indicate whether two or more employees' commute can be optimized if the two or more employees commute together. Moreover, in some embodiments, commuting metrics for employees of two or more employers can analyzed, compared, ranked, and the like. That is, some embodiments need not limit location data 205 and commute data 210 for one employer, business, or other entity. It should be understood that use of the terms “employee” and “employer” in the above description is not limiting. That is, embodiments can be used for any type of commuter and any type of destination. For example, some embodiments can be used to determine commuting metrics for business franchises and their customers, voting locations, volunteer organizations, transportation agency planning, and the like.

In some instances, commute optimization module 225 can determine a potential commuting metric value for a commuter and for more than one location to determine which location provides the best commute according to that commuting metric. For example, an employer with multiple locations can determine a potential commuting metric value for each employee or each of a select group of employees and two or more of the locations. In this way, an employer can determine a group of commuting metric values or an aggregate commuting metric value for a scenario involving multiple employees and make decisions about which employee should commute to which location. In another example, commute optimization module 225 can determine a potential commuting metric value for a commuter for another location, resulting in a swap indicator corresponding to an employee to fill an opening at a different employer location for the same or different employer or corresponding to two or employees to swap locations and/or positions for the same or different employer.

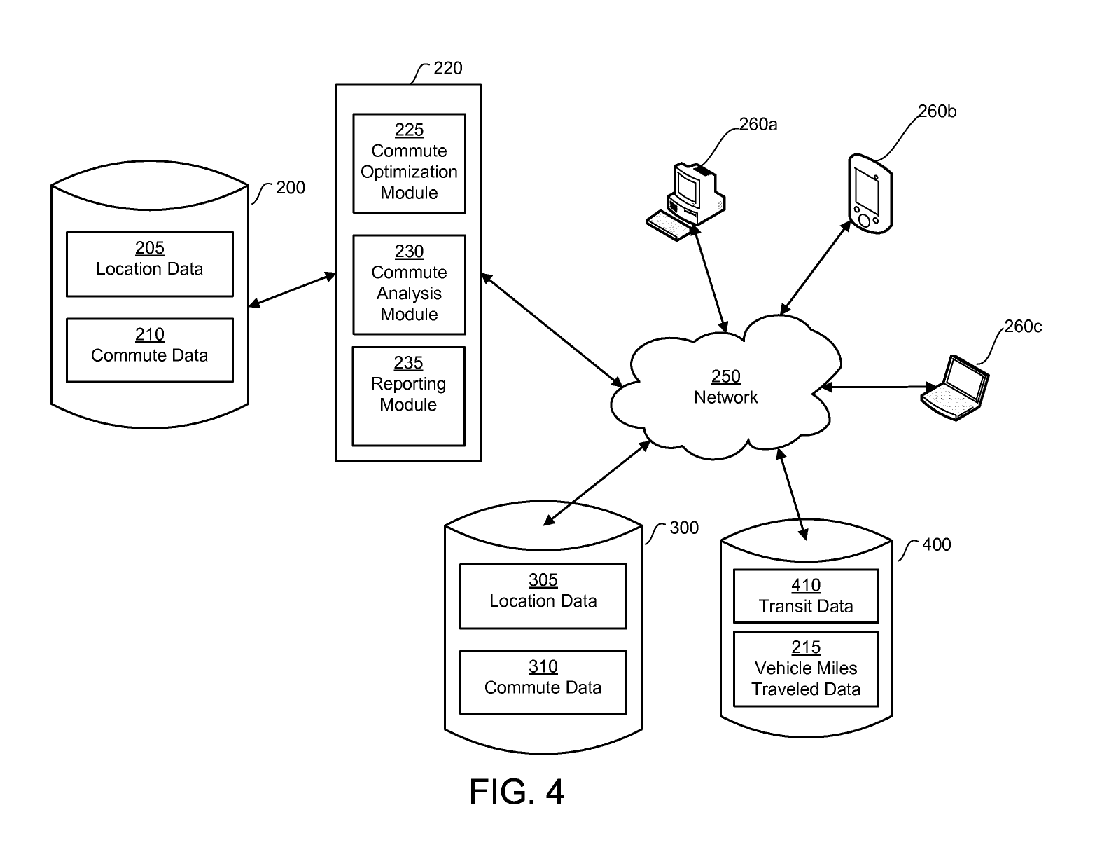

In some instances, commute optimization module 225 can determine potential commuting metric values based on alternative modes of transportation, alternative routes, alternative commuting times, and the like. Referring now to FIG. 4, commute optimization module 225 can use transit data 410, which can include public transportation data (e.g., planned and actual schedules, schedule history, planned and actual outages, and the like), to determine a commuting metric value for one or more commuting alternatives. In this way, employers can assist employees with commuting choices or commuters can determine more suitable commuting alternatives.

Returning to FIG. 2, in some embodiments, commute optimization module 225 can determine a potential commuting metric value for two or more commuters based on the two or more commuters sharing at least a part of a route, for example, if two or more commuters were to carpool. Commute optimization module 225 can determine commuting metric values for alternative carpool arrangements as well. For example, commuters may have the availability to carpool during different legs of a commute and use different modes of transportation during different legs of the commute.

In some instances, commute optimization module 225 can update location data 205 or 305, commute data 210 or 310, vehicle miles traveled data 215, transit data 410, or some other data source with commuting metric data. For example, commute optimization module 225 can update a data source to maintain a history of commuting metrics. In this way, commuting metrics can be determined periodically or by request (e.g., user request, upon a change to location data 205, commute data 210, vehicle miles traveled data 215, transit data 410, or some other data source, etc.) to determine which employees can be swapped from one location to another to reduce their overall vehicle miles traveled in relation to commute.

Commute analysis module 230 can communicate with commute optimization module 225 to receive commuting metrics for analysis. In some embodiments, commute analysis module 230 can receive data from data store 200 separately or in conjunction with receiving data from commute optimization module 225. Commute analysis module 225 can analyze whether a location has a job opening or whether an employee is eligible to swap a current location for the location with a job opening. In some instances, commute analysis module 225 can associate employee identifying data (e.g., name, employee number, social security number, or some other unique or other identifying data) with the location data or job opening data. Furthermore, commute analysis module 230 can analyze commuting metrics and values to generate rankings of commuting metrics and their values, assign weights to commuting metrics, aggregate commuting metrics and values, and the like.

In some embodiments, commute analysis module 230 can update location data 205 and 305, commute data 210 and 310, vehicle miles traveled data 215, transit data 410, or some other data source with commuting metric data. For example, commute analysis module 230 can update a data source to maintain a history of commuting metrics. In this way, commuting metrics can be determined periodically or by request (e.g., user request, upon a change to location data 205, commute data 210, vehicle miles traveled data 215, transit data 410, or some other data source, etc.).

Commute analysis module 230 can be used to implement a “swap queue” to generate a ranking of employees for transfer to another location or to otherwise suggest one or more employees for transfer to another location. In some instances, commute analysis module 230 can receive commuting metric values for one or more employees with a corresponding commuting metric value at a predetermined threshold and combine an eligibility metric value with the commuting metric value. An eligibility metric value can be based on whether an employee is suitable for a position at another location, regardless of the employee's corresponding commuting metric value. An eligibility metric value can be based on an employee's performance, job skills, job experience, and the like.

In some instances, commute analysis module 230 can rank employees according to a combination of commuting metric values and eligibility metric value or according to one or the other. In other instances, commute analysis module 230 can generate a binary indicator for whether the commuting metric values and/or eligibility metric values are at a predetermined threshold indicating the employee is suitable for the open position. Commute analysis module 230 can generate a “swap queue” in response to a request or periodically rebuild a “swap queue.” Moreover, a “swap queue” can be generated based on input parameters, such as location, job skills for an open position, employee performance, employee tenure, job experience required, commuting metric indicator, and the like. The foregoing input parameters can be received by commute analysis module 230, or some other module, as input from a device 260a-c or as input from location data 205, 305, commute data 210, 310, or some other data source.

In some instances, employees can initiate a “swap queue.” For example, server 220 can include a module for posting job openings for presentation at a device, such as a device 260a-c. Commute analysis module 230 can then receive a request from a device 260a-c to generate a “swap queue” that includes information corresponding to a particular employee that sent the request. The employee can login through a web page and submit information and/or a command to enter that employee into the “swap queue.” In some embodiments, “swap queues” can be created and maintained to track employees' interest in transferring away from a current location or to a different location regardless of the existence of any open positions. In this way, employers can have information about where future locations should be planned, have insight into employee satisfaction, or simply have an ongoing “swap queue” in the event of turnover.

Commute analysis module 230 can analyze historical commute data to determine likely commuting metrics and their values that impact employee turnover. For example, commute analysis module 230 can determine the average or median commute time, commute cost, commute distance, or some other commuting metric for employees who have left their jobs, requested transfers, and the like and for those who have not. In some embodiments, commute analysis module 230 can determine a turnover rate based on one or more commuting metrics. For example, commute analysis module can determine a turnover rate for predetermined commuting times (e.g., turnover rate at over 60 minutes of commute time, 45-60 minutes of commute time, 30-45 minutes of commute time, 30 minutes of commute, etc.). One or more predetermined commuting times or commuting time ranges can be used. Moreover, a commuting time or commuting time range can be received as an input from a device 260a-c or from data store 200, data store 300, or some other data store. Turnover rate can be based on commute distance, commute cost, or another commuting metric also. In some embodiments, commute analysis module 239 can correlate commuting metric values or commuting metrics to a turnover threshold. That is, commute analysis module 230 can determine which commuting metrics or commuting metric values contribute to turnover and at what threshold value of a commuting metric a turnover rate occurs. In this way, some embodiments can be used to predict employee turnover before it happens.

In some embodiments, server 220 can receive parameter data that can indicate how commuting metric values are determined and/or analyzed and/or how commuting metric analyses are generated and/or displayed. For example, server 220 can receive, through a network communications interface, a parameter(s) controlling which commuting metric is determined, how it is determined, how commuting metrics are analyzed, how analysis results are presented or sent, and the like.

Reporting module 235 can communicate with commute optimization module 220, commute analysis module 225, or both to receive commuting metric data and/or analysis and can host and/or present analysis reporting data for devices 260a-c or for other devices (e.g., computers in communication with server 220 in an internal network). Reporting module 235 can generate an electronic file that includes data representing commuting metrics, commuting metrics analysis, or both.

In some instances, reporting module 235 can generate an electronic file including a message (e.g., audio file, one or more short message service (SMS) packets, one or more multimedia messaging service (MMS) packets, other types of messaging, email, etc.) for delivery to a device 260a-c or other device. Reporting module 235 can also generate an electronic file including an instruction to store commuting metrics, commuting metric analysis, or both in a data store (e.g., database server, etc.). Further, reporting module 235 can generate another type of electronic file (e.g., text file, graphic file, or other type of media) for delivery to a device (e.g., email server, ftp server, etc.), or for presentation. In some embodiments, reporting module 235 can generate a Hypertext Markup Language (HTML) file, Extensible Markup Language (XML) file, JavaScript Object Notion (JSON) file, geographic information system (GIS) file, Keyhole Markup Language (KML) file, Global Position System Exchange Format (GPX) file, or some other type of markup language file for display or delivery to a device or for hosting at server 220. For example, reporting module 235 or some other module can include a web server that serves a commuting metric analysis result, for example, in HTML or other markup language, based on a request. Many types of markup languages can be used to format results for presentation on a device.

In some embodiments, commuting metric values, commute analysis results, or both can be used by a business or other entity (e.g., government agency, consultant, planner, etc.) to understand potential commute information, including potential commuting metrics for one or more commuters to travel to one or more locations and make recommendations as to which employee(s) to swap. It should be understood that server 220 can host or communicate with other modules to render results for a user. For example, server 220 can include an email server, ftp server, and the like. Additionally, server 220 can include a module for delivering an electronic file containing commute analysis results to a cloud service or some other external data store accessible to a device 260a-c.

Server 220 can include a reporting module 235 to display digital graphic commuting metrics, route information (e.g., maps, directions, etc.) and the like. Reporting module 235 can generate for display HTML, XML, JSON, GIS, KML, GPX, or some other type of markup language for the display. Reporting module 235 can generate for display or display commuting metric values in text or graphic format, such as color coded ranking or listing of commuter metrics or charts. For example, a ranking of commuting metrics for one or more commuters can be displayed for one or more locations. Further, reporting module 235 can generate for display or display maps, routing information, directions, and the like. It should be understood that in some embodiments, commute analysis module 230 or some other module can generate an electronic file (i.e., electronic file, message, signal, etc.) for display or delivery by reporting module 235 or some other module.

In some embodiments, commute optimization module 225, commute analysis module 230, and reporting module 235 each can be further separated into subsystems or modules and can be further combined into a single system or module. Furthermore, in some embodiments each module or can be hosted by different hardware at the same or different location or distributed across a network and/or locations. It should be understood that server 220 can host other modules and is not limited to the modules shown in FIG. 2.

Server 220 can include one or more modules for sending and/or receiving location data, commute data, and other data to or from data store 200. In some embodiments, commute optimization module 225, commute analysis module 230, or both can send or receive data to or from data store 200. In some embodiments, server 220 can receive data for storage in data store 200 via a user interface, a network communications interface, from network 250, or some combination thereof.

In some embodiments, server 220 can communicate with network 250 to receive and/or send data from additional databases and systems. For example, devices 260a-c can communicate with server 220 through network 250 to receive and/or send data. Devices 260a-c can include computer servers (e.g., email servers, ftp servers, etc.), personal computers, laptops, tablets, smartphones, other handheld devices, or other types of computing devices. Server 220 can receive requests to generate commuting metric values and/or analysis based on data stored in data store 200 or some other data source or based on data received from device 260a-c. For example, server 220 can receive, from a device 260a-c, any type of location data and commute data, including, but not limited to, commuter, route, or location information, direction data, address data, coordinate data, transportation schedule data, maintenance schedule data, outage data, entity identifier data, entity location identifier data, and the like.

Although some embodiments can be used by employers or agencies to determine optimal commute routes for businesses and their employees, it should be understood that some embodiments can be used to optimize commutes regardless of whether the commuter is an employee or the location to which the commuter is traveling is an employer. That is, some embodiments can be used to optimize any commute.

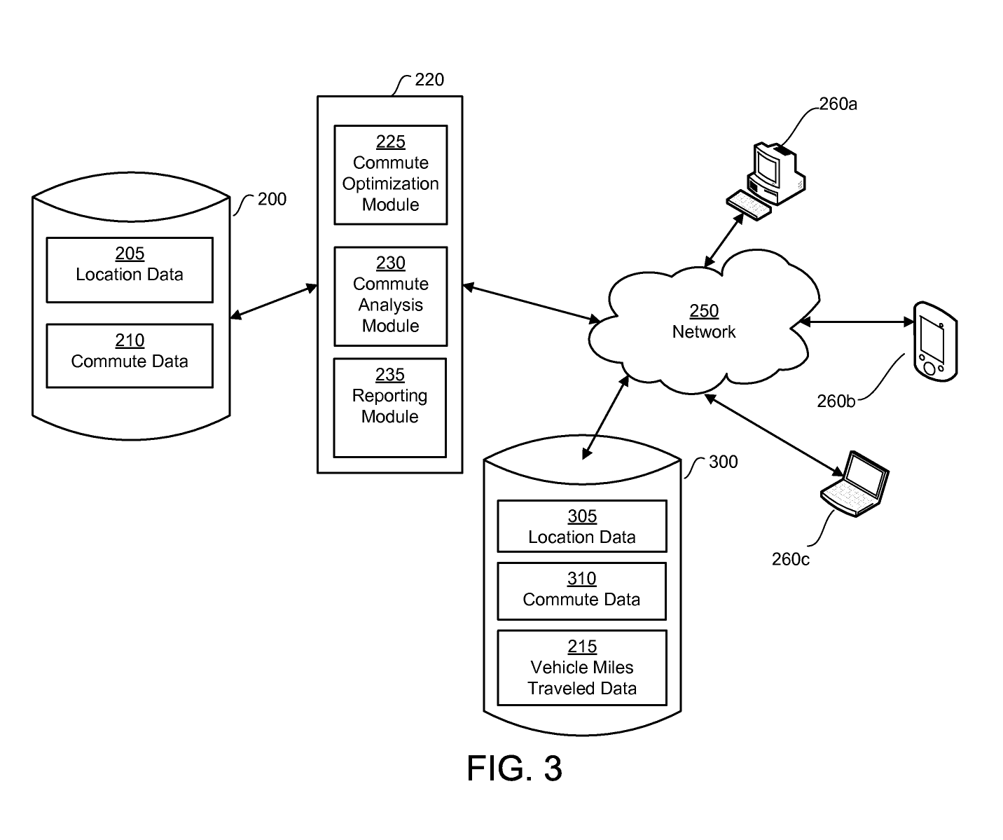

FIG. 3 illustrates an embodiment in which data store 300 hosts location data 305 and commute data 310. Data store 300 can be structured the same as data store 200 or differently. For example, the embodiment illustrated, vehicle miles traveled 215 is hosted with location data 305 and commute data 310. It should be understood that, in some embodiments vehicle miles traveled can be hosted, entirely or in part, at data store 200 or some other data store. In some embodiments, data store 300 can be hosted by a computer server maintained by the same or different entity maintaining data store 200 and/or located at the same or different location as data 200. For example, data store 300 can be hosted, maintained, operated, or controlled by another entity (e.g., agency, business, private user, etc.) that does or does not use server 220. Data store 300 can also be hosted, maintained, operated, or controlled by another entity other than an entity using server 220. For example, an entity may track commute data or location data that is useful for determining a commuting metric but that is not maintained or tracked by the entity maintaining data store 200.

FIG. 4 illustrates an embodiment which further includes data store 400 storing transit data 410. Transit data 410 can include information from government or private agencies regarding public transportation, including bus, rail, plane, and other schedules; planned and current outages, upcoming changes, maintenance schedules, on-time information, capacity information, and the like. In some instances, transit data 410 can include information from public or private transportation agencies regarding road maintenance, including planned or current roadwork or bridgework and the like. Server 220 can receive transit data 410 as input for commute optimization module 225, commute analysis module 230, or another module to determine current or potential commuting metric values. In some instances, server 220 can receive transit data 410 by way of devices 260a-c.

In some instances, commute analysis module 230 can generate changes to transit data 410 and send change data to transit data 410 for use by agencies or other users of transit data 410. For example, commute analysis module 230 can compare current commuting metric values to transit data 410 and determine whether and to what extent transit data 410 is inaccurate. Agencies responsible for maintaining transit data 410 can then make adjustments to transit data 410 to reflect more the accurate information. In some embodiments, server 220 can include a module that automatically updates transit data 410 on behalf of an agency. In some embodiments, a module other than commute analysis module 230 can be configured to generate changes to transit data 410 and/or return change data.

In some instances, commute data 210 can be augmented with transit data 410. For example, commuting metrics history data can be associated with public transportation schedule data, public transportation outage data, road maintenance data, and the like so that commuting metrics history data can be analyzed in context. That is, transit data 410 associated with commute data 210 can be used to analyze, optimize, and/or determine commuting metrics history, current commuting metrics, and potential commuting metrics. For example, a commuting metrics history data can include route data that includes a public transportation route segment and, over time, the public transportation route segment schedule or route may change, experience outages, experience maintenance. Thus, it can be determined whether a commuting metric, for example, commute time, would accurately reflect a current or potential commuting metric using the same route data.

FIG. 4 also illustrates an embodiment in which vehicle miles traveled data 215 is hosted with transit data 410. In some instances, vehicle miles traveled data can be hosted, maintained, operated, or controlled by the same or different entity that hosts, maintains, operates, or controls transit data 410. Furthermore, in some instances, a transportation agency can host, maintain, operate, or control one or more portions of transit data 410 and/or vehicle miles traveled 215 and server 220, or some module of server 220, can receive data from transit data 410 and/or vehicle miles traveled 215 to determine the value of the commuting metric. For example, a transportation agency, or some other governmental or quasi-governmental agency, can institute a vehicle miles traveled (VMT) tax. In some cases, such a VMT tax can be in lieu of, or in addition to, a fuel tax. In such a case, the agency can track VMT. Some embodiments can then use the VMT data collected by the agency to determine a commuting metric for an employer, employee, other commuter, or another interested in commuting issues. Furthermore, in some instances, server 220, or some module of server 220, can update transit data and/or vehicle miles traveled. It should be understood, transit data 410 and vehicle miles traveled 215 can be further separated or combined and/or distributed across a network and/or different locations. In some embodiments, reporting module 235 can provide reporting information on VMT data from vehicle miles traveled data 215 and/or from another data source.

Furthermore, in some instances, location data 205 and commute data 210 can store data for one or more potential employer locations and one or more employee commuter location data, respectively. In such instances, commute analysis module 230 and/or commute optimization module 225 can analyze location data 205, commute data 210, and transit data 410 (e.g., future public transportation schedules and routes, planned new roadways, and other digital traffic planning information, and the like) to determine an optimal location for a potential employer location.

In some instances, location data 205, commute data 210, transit data 410, or some combination thereof can include data for planning organizations to optimize public transportation schedules and maintenance, to plan public transportation routes, and the like.

In some instances, commute data 210 can include optimal commute information associated with a commuter, such as directions, map, routes, commute times, and the like. In some instances, server 220 can send to devices 260a-c potential commute data, including potential commuting metric values for multiple locations. For example, a prospective or current employee can receive information at a device 260a-c regarding which of two employer locations is more optimal for commuting.

FIG. 5 illustrates a method 500 for analyzing commuting metrics according to an embodiment. At 510, an activation signal is received. In some embodiments, an activation signal may be a request from a user to analyze and send commuting metric values or an automated signal. An automated signal may be generated by an event, such as a job opening, a new employee hire, a transfer or swap by one or more employees, a change to a public transportation schedule, maintenance on a route, and the like. An event can be some change to location data 205, commute data 210, transit data 410, or a change to some other data. Further, an automated signal may be a regularly scheduled signal to analyze commuting metrics. At 520, location data is requested. Server 220 can request location data from data store 200 or from another source. In some embodiments, another source for location data can be user input or a database other that data store 200. At 530, location data is received.

At 540, commute data is requested. Again, server 220 can request commute data from data store 200 or from another source. In some embodiments, another source for commute data can be user input or a database other than data store 200. At 550, commute data is received. At 560, commuting metric indicator is received. In some embodiments, a commuting metric indicator can indicate the number of commuting metrics, which particular commuting metrics, and the like are to be determined. The commuting metric indicator can be received along with the activation signal received at 510 or separately. In some embodiments, a commuting metric can be received from an interface for user input. Furthermore, in some embodiments, a commuting metric can be predetermined based on either permanent or selectable settings. For example, server 220 or data store 200 can include settings for commuting metric values to be determined. Moreover, commuting metric values to be determined can be based on an employer or other entity, a location, a commuter, some other parameter, or some combination thereof.

At 570, a value of a commuting metric is determined. In some embodiments, a commuting metric value can be a raw value such as distance to location, maximum time to location over a period, minimum time to location over a period, and the like. In some embodiments, a commuting metric value can be a derived value such as average distance to location for all or a subset of routes, including private and/or public transportation, or a ranking of a route, commuter, location, or some combination thereof among multiple routes, commuters, locations, or some combination thereof. In some embodiments, a commuting metric can be an indicator of an optimal route, location, or employee.

At 580, a commuting metric analysis result is generated. The commute analysis result can be, for example, one or more of the commuting metrics and their values determined. A commuting metric comparison analysis result can be one or more of the commuting metrics values determined and can be generated as an electronic file with data and/or instructions (e.g., instructions for displaying data as in a markup language file, instructions for storing data in a database, etc.). In some embodiments, the commuting metric analysis result can include other information or formatting of commuting metric values for display on a device. A commuting metric analysis result can include recommended locations (including, for employee transfers or swaps, whether a transfer would be an employee transfer to an open position or a swap of employees and locations) based on commuting metric values, ranking of recommended locations, graphic commuting metric values, route information, directions, maps, and the like. In some embodiments, the values of one or more commuting metrics can be included as part of the commuting metric analysis result. In this way, a comparison can be performed at a device 260a-c, via reporting module 235, and the like. In some instances, the commuting metric analysis result can include graphic information representing the commuting metric value(s) or information derived from a commuting metric value(s). For example, commuting metric values can be represented by color coding (e.g., color coding of a list, color coding on a map, etc.), one or more graphs, and the like. In some instances, the commuting metric analysis result that can include commuting metric value information (i.e., commuting metric values or information derived from commuting metric values) combined with other information. For example, map data, employee schedule data, or other pre-existing data can be marked up or augmented with commuting metric value information.

At 590, a signal representing the commuting metric analysis result is sent. In some embodiments, a signal representing a commuting analysis result can include other information or formatting of the commuting metric values for display on a device. For example, a commute analysis result can be sent via email, to a printer, to reporting module 235, some combination thereof, and the like and can include commuting metric analysis result information from step 580. It should be understood that a signal representing the commuting metric analysis result can be sent in accordance with embodiments further described herein and, in particular, in connection with reporting module 235.

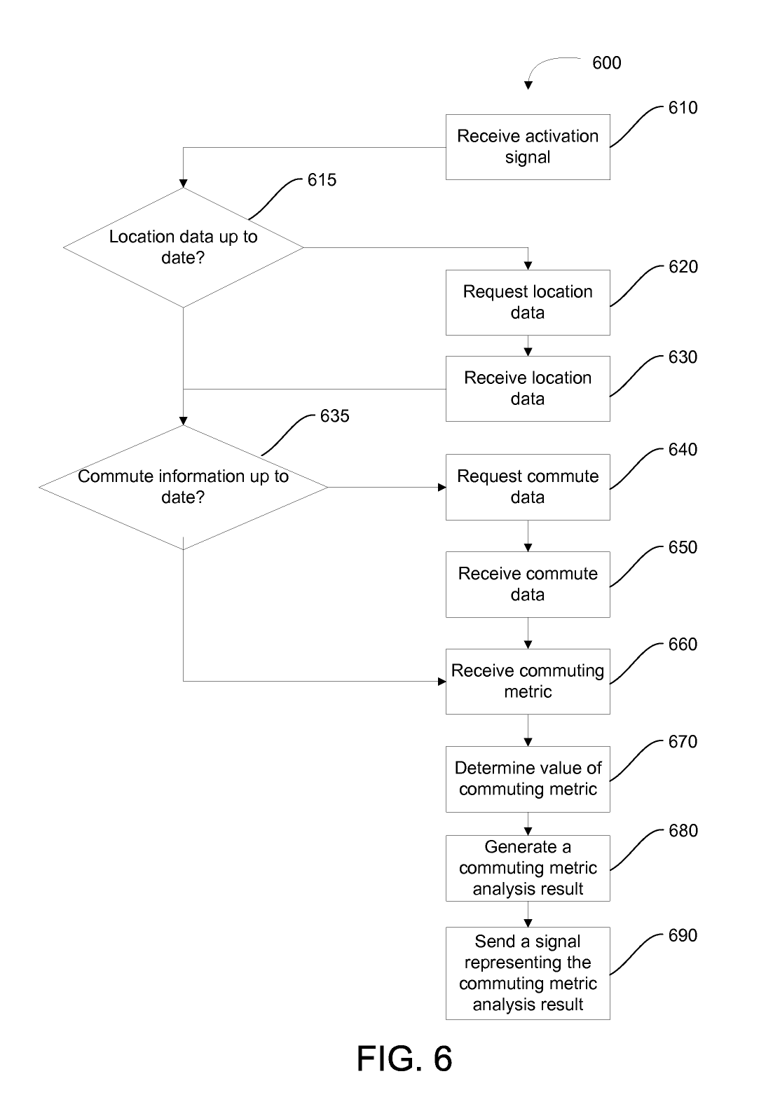

FIG. 6 illustrates a method 600 for analyzing commuting metrics according to an embodiment. At 610, an activation signal is received. At 615, whether location data are up to date is determined in response to the activation signal. If they are not, at 620, location data are requested and at 630, location data are received. If they are, at 635, whether commute data are up to date is determined. If they are not, at 640, commute data are requested and at 650 commute data are received. In some embodiments, whether data are up to date is not determined and the data is always requested and received. In some embodiments, location data, commute data, or both are periodically checked. In some embodiments, location data, commute data, or both are checked, requested, and received independent of an activation signal or any other type of request to analyze commuting metrics. At 660, a commuting metric indicator is received; at 670, a value of a commuting metric is determined; at 680, a commuting metric analysis result is generated; and at 690, a signal representing the commuting metric analysis result is sent.

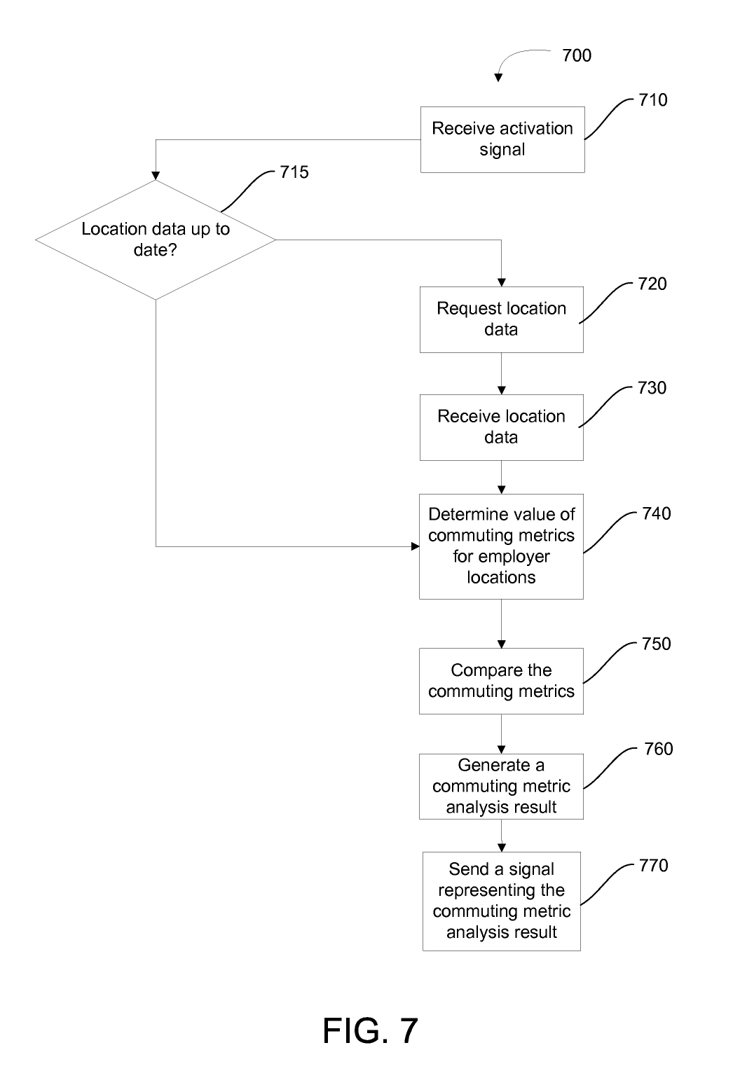

FIG. 7 illustrates a method 700 for analyzing commuting metrics according to an embodiment. At 710, an activation signal is received. At 715, whether location data are up to date is determined. If they are not, at 720, location data are requested and at 730, location data are received. If they are, at 740 commuting metrics for employer locations is determined. In some embodiments, a single commuting metric for each employer location can be determined. In some embodiments, more than one commuting metric for each employer location can be determined.

At 750, the commuting metrics are compared. In some embodiments, a single commuting metric value for each location can be compared, multiple raw commuting metric values for each location can be compared, more than one weighted commuting metrics for each location can be compared, or one or more derived metrics, either weighted or unweighted, for each location can be compared. Which commuting metrics are compared, whether commuting metrics are weighted, the weighting, and the like can be static (i.e., not selectable), predetermined based on a selection (e.g., based on a setting in data store 200), based on user input, or some combination thereof. In some embodiments, a comparison can include a simple ranking of employer locations or weighting of employer locations. At 760, a commuting metric analysis result is generated and, at 770, a signal representing the commuting metric analysis result is sent.

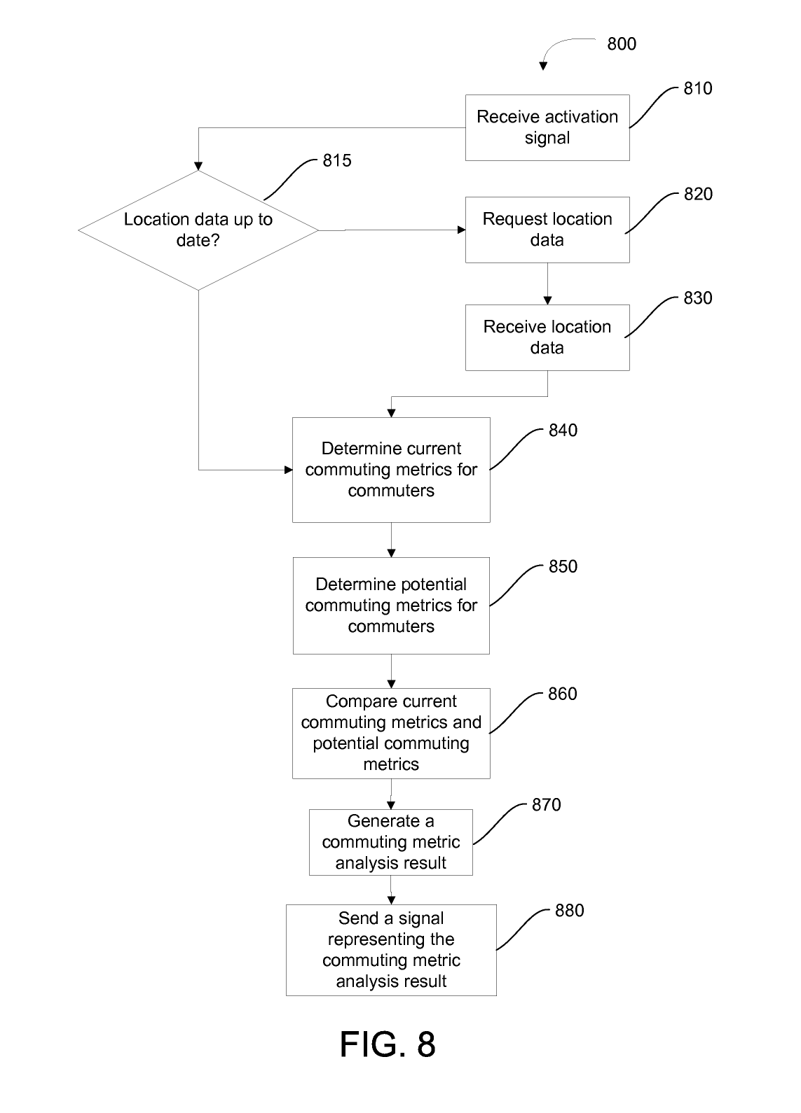

FIG. 8 illustrates a method 800 for analyzing commuting metrics according to an embodiment. At 810, an activation signal is received. At 815, whether location data are up to date is determined. If they are not, at 820, location data are requested and at 830, location data are received. At 840, current commuting metrics for commuters is determined. At 850, potential commuting metrics for the commuters is determined. Current commuting metrics can be based on current commuting requirements for the commuters. Potential commuting metrics can be based on different destination locations for the commuters. Potential destination locations for different commuters can differ or be the same.

At 860, current commuting metrics and potential commuting metrics are compared. In some embodiments, commuting metrics can be compared to determine whether a commuter has a more optimal commute for a destination location than another commuter. In some embodiments, a comparison can be made to determine which of two or more destination locations is more optimal based on an aggregate of commuting metrics for the commuters. Furthermore, in some embodiments a comparison can be made to determine a change in commuting metric values based on transit data 410. For example, scheduled road maintenance can effect commuting metric values and a comparison can be made to determine the change to commuting metric values for individual commuters or commuters collectively. Moreover, a comparison can be made for multiple destination locations based on transit data 410. For example, scheduled road maintenance, a change to public transportation schedules, the addition or subtraction of services, and the like can effect commuting metric values for multiple employers or other entities and a comparison can be made to determine the change to commuting metric values for individual commuters or commuters collectively. At 870, a commuting metric analysis result is generated and, at 880, a signal representing the commuting metric analysis result is sent.

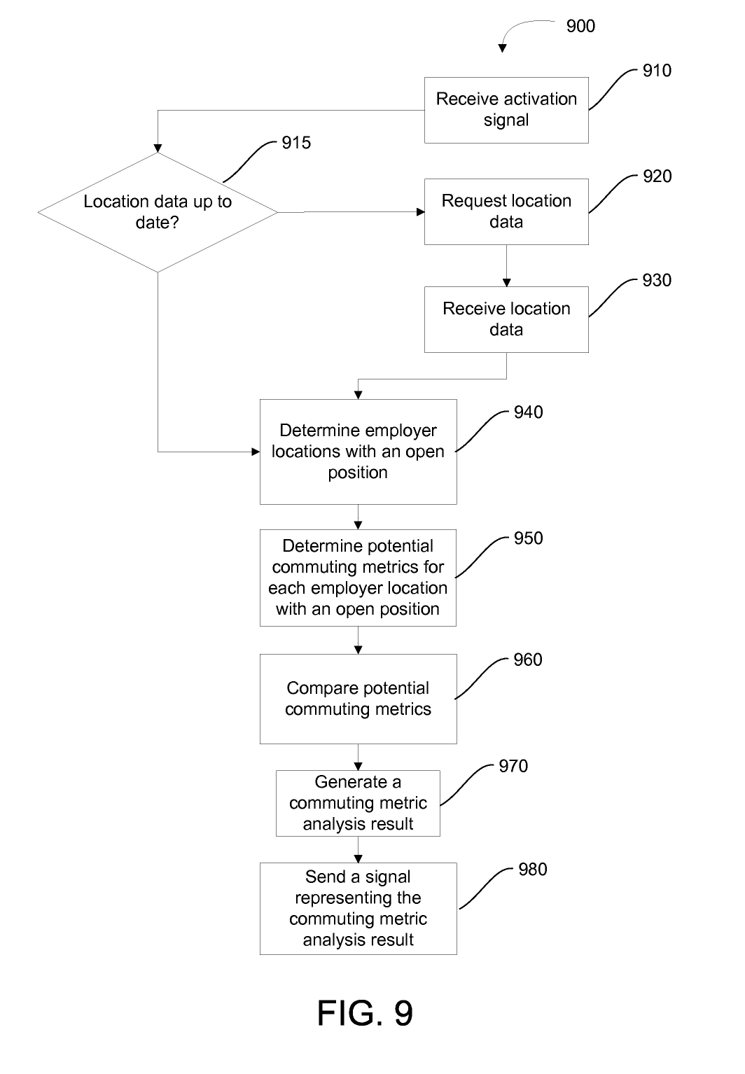

FIG. 9 illustrates a method 900 for analyzing commuting metrics according to an embodiment. At 910, an activation signal is received. At 915, whether location data are up to date is determined. If they are not, at 920, location data are requested and, at 930, location data are received. At 940, employer locations with an open position are determined. Open position data can be included in location data 205 or received as input through an interface. In some embodiments, open position data for more than one employer can be determined. At 950, potential commuting metrics for each employer location with an open position are determined. Potential commuting metrics for one or more commuters can be determined. At 960, potential commuting metrics are compared. At 970, a commuting metric analysis result is generated and, at 980, a signal representing the commuting metric analysis result is sent.

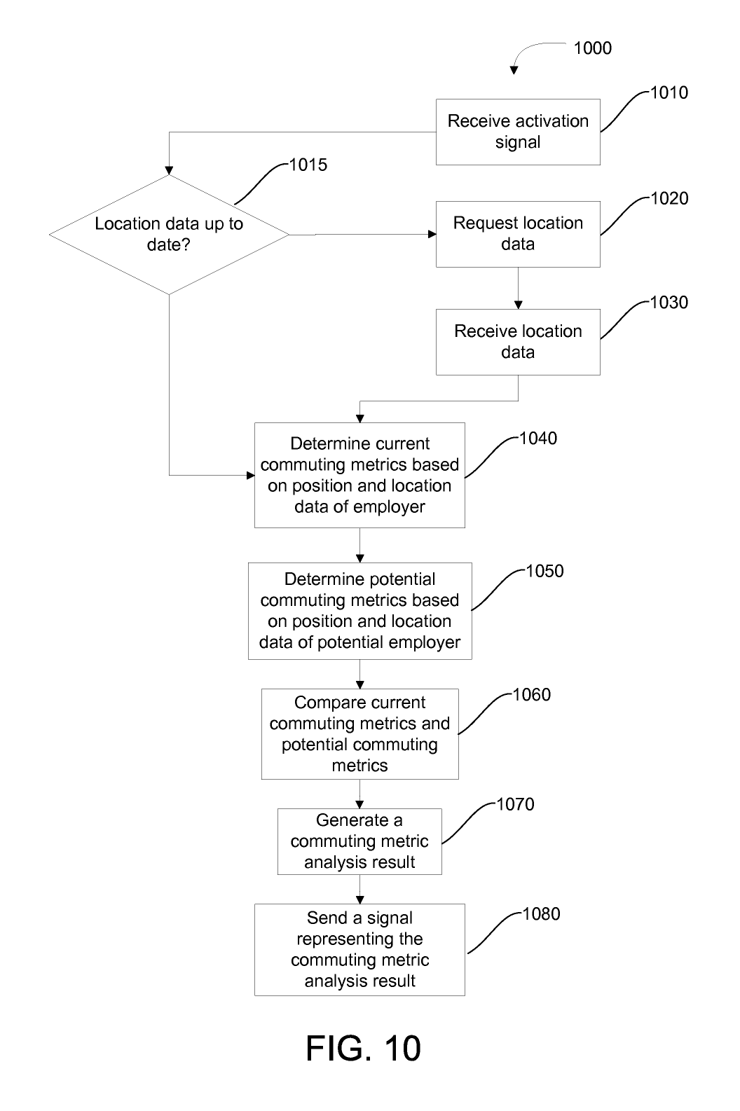

FIG. 10 illustrates a method 1000 for analyzing commuting metrics according to an embodiment. At 1010, an activation signal is received. At 1015, whether location data are up to date is determined. If they are not, at 1020, location data are requested and at 1030, location data are received. At 1040, current commuting metric values based on location data of an associated employer are determined. At 1050, potential commuting metric values based on location data of an associated potential employer are determined. At 1060, the current commuting metric values and potential commuting metric values are compared. In some embodiments, commuting metric values can be compared to determine whether another employer location for the same or different associated employer is more optimal for a commuter's commute than the commuter's current employer location. At 1070, a commuting metric analysis result is generated and, at 1080, a signal representing the commuting metric analysis result is sent.

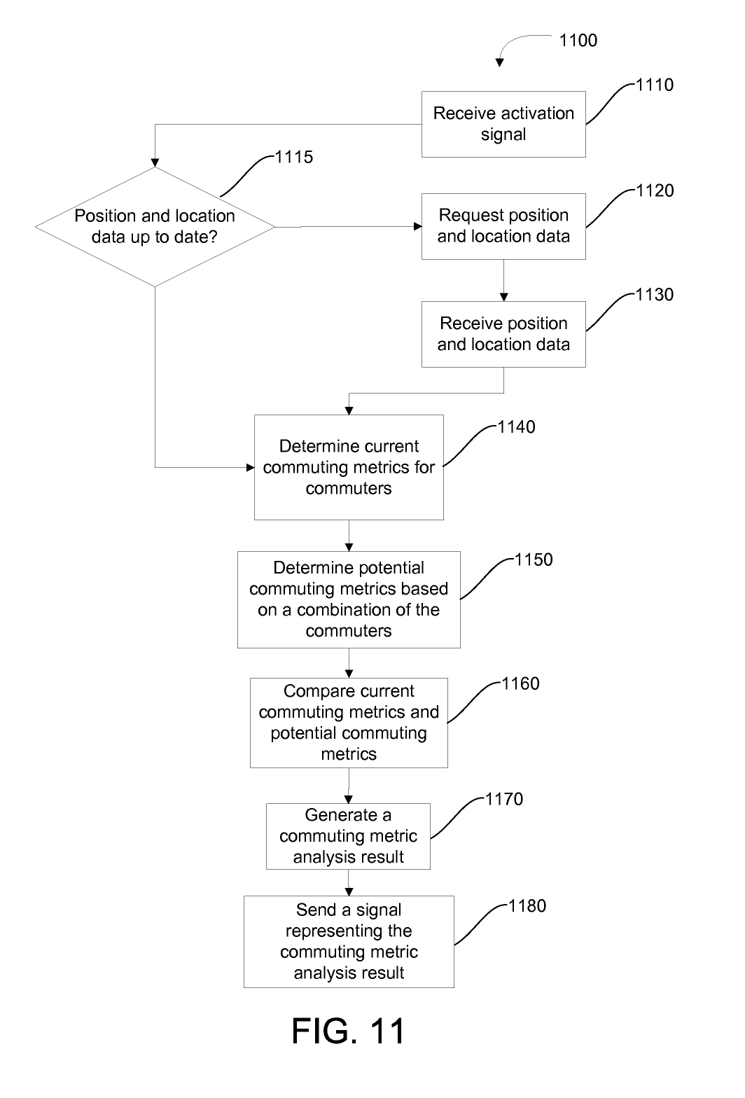

FIG. 11 illustrates a method 1100 for analyzing commuting metrics according to an embodiment. At 1110, an activation signal is received. At 1115, whether location data are up to date is determined. If they are not, at 1120, location data are requested and at 1130, location data are received. At 1140, current commuting metric values for commuters are determined. At 1150, potential commuting metric values based on the commuters is determined. In some embodiments, potential commuting metric values for a subset of the set of commuters can be determined. The subset can be based on location of the commuters, the commuters' destination location (e.g., employer location associated with those commuters), or some other commuter data such as type of routes or modes of transportation taken (e.g., mostly highway, public transportation, use of bicycle, pedestrian, etc.), and the like.

At 1160, current commuting metric values and potential commuting metric values are compared. At 1170, a commuting metric analysis result is generated and, at 1180, a signal representing the commuting metric analysis result is sent. In some instances, the commuting metric analysis result can include an optimal new employer location, ranking of potential new employer locations, resulting, the effect of a changed to transit data 410 on commuters, and the like.

Some embodiments described herein relate to a computer storage product with a non-transitory computer-readable medium (also referred to as a non-transitory processor-readable medium) having instructions or computer code thereon for performing various computer-implemented operations. The computer-readable medium (or processor-readable medium) is non-transitory in the sense that it does not include transitory propagating signals (e.g., propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

In conclusion, disclosed embodiments provide, among other things, a system and method for managing, analyzing, and optimizing commuting metrics for commuters, businesses, and agencies. Those skilled in the art can readily recognize that numerous variations and substitutions may be made to the disclosed embodiments, their use and their configuration to achieve substantially the same results as achieved by the embodiments described herein. Accordingly, there is no intention to limit the disclosed embodiments or the claimed inventions to the disclosed exemplary forms. Many variations, modifications and alternative constructions fall within the scope and spirit of the inventions as expressed in the claims.

What is claimed is:

1. A method comprising:
receiving, via a computer interface, location data for a plurality of locations associated with an entity, the location data including physical location data, the computer interface selected from at least one of a user interface or network communications interface;
receiving commuter data for a plurality of commuters, the commuter data for each commuter from the plurality of commuters including commute start location data;
determining a plurality of values of a commuting metric, each value from the plurality of values of the commuting metric being based on one of the physical location data and one of the commute start location data; and
generating an electronic file including at least one of the plurality of values of the commuting metric.

2. The method of claim 1, wherein the commuting metric is selected from at least one of a commute time, a commute distance, a commute expense, a fuel consumption, or an emissions generated.

3. The method of claim 1, wherein the plurality of values of the commuting metric includes:
a first potential commuting metric value associated with a first commuter and a first location, a second potential commuting metric value associated with the first commuter and a second location, a third potential commuting metric value associated with a second commuter and the first location, and a fourth potential commuting metric value associated with the second commuter and the second location.

4. The method of claim 3, further comprising:
comparing the first potential commuting metric to each of the second, third, and fourth potential commuting metrics to determine a first, second, and third comparison result, respectively;
comparing the second potential commuting metric to each of the third and fourth potential commuting metrics to determine a fourth and fifth comparison result, respectively;
comparing the third potential commuting metric to the fourth potential commuting metric to determine a sixth comparison result; and
generating ranking data for each respective comparison result,
the generating the electronic file includes writing the ranking data to the electronic file.

5. The method of claim 1, further comprising:
receiving an activation signal that includes an instruction to determine the plurality of values of the commuting metric.

6. The method of claim 5, wherein the activation signal includes a data source change indicator, the data source change indicator identifying at least one of location data that has changed and commuter data that has changed.

7. The method of claim 1, further comprising:
sending, via the network communications interface, the electronic file, the electronic file being generated in a markup language format.

8. A system comprising:
a server having a processor, a memory, and network communications interface, the server configured to:
receive, via the network communications interface, location data for a plurality of locations associated with an entity, the location data including physical location data;
receive commuter data for a plurality of commuters, the commuter data for each commuter from the plurality of commuters including commute start location data;
determine a plurality of values of a commuting metric, each value from the plurality of values of the commuting metric being based on one of the physical location data and one of the commute start location data; and
generate an electronic file including at least one of the plurality of values of the commuting metric.

9. The system of claim 8, wherein the commuting metric is selected from at least one of a commute time, a commute distance, a commute expense, a fuel consumption, or an emissions generated.

10. The system of claim 8, wherein the plurality of values of the commuting metric includes:
a first potential commuting metric value associated with a first commuter and a first location, a second potential commuting metric value associated with the first commuter and a second location, a third potential commuting metric value associated with a second commuter and the first location, and a fourth potential commuting metric value associated with the second commuter and the second location.

11. The system of claim 10, wherein the server is further configured to:
compare the first potential commuting metric to each of the second, third, and fourth potential commuting metrics to determine a first, second, and third comparison result, respectively;
compare the second potential commuting metric to each of the third and fourth potential commuting metrics to determine a fourth and fifth comparison result, respectively;
compare the third potential commuting metric to the fourth potential commuting metric to determine a sixth comparison result;
generate ranking data for each respective comparison result; and
write the ranking data to the electronic file.

12. The system of claim 8, wherein the server is further configured to:
receive an activation signal that includes an instruction to determine the plurality of values of the commuting metric.

13. The system of claim 12, wherein the activation signal includes a data source change indicator, the data source change indicator identifying at least one of location data that has changed and commuter data that has changed.

14. The system of claim 8, wherein the server is further configured to:
send, via the network communications interface, the electronic file; and
generate the electronic file in a markup language format.

15. A non-transitory processor-readable medium including instructions comprising instructions for:
receiving, via a computer interface, location data for a plurality of locations associated with an entity, the location data including physical location data, the computer interface selected from one of a user interface or network communications interface;
receiving commuter data for a plurality of commuters, the commuter data for each commuter from the plurality of commuters including commute start location data;
determining a plurality of values of a commuting metric, each value from the plurality of values of the commuting metric being based on one of the physical location data and one of the commute start location data; and
generating an electronic file including at least one of the plurality of values of the commuting metric.

16. The non-transitory, processor-readable medium of claim 15, wherein the commuting metric is selected from at least one of a commute time, a commute distance, a commute expense, a fuel consumption, or an emissions generated.

17. The non-transitory, processor-readable medium of claim 15, wherein the plurality of values of the commuting metric includes:
a first potential commuting metric value associated with a first commuter and a first location, a second potential commuting metric value associated with the first commuter and a second location, a third potential commuting metric value associated with a second commuter and the first location, and a fourth potential commuting metric value associated with the second commuter and the second location.

18. The non-transitory, processor-readable medium of claim 17, further comprising instructions for:
comparing the first potential commuting metric to each of the second, third, and fourth potential commuting metrics to determine a first, second, and third comparison result, respectively;
comparing the second potential commuting metric to each of the third and fourth potential commuting metrics to determine a fourth and fifth comparison result, respectively;
comparing the third potential commuting metric to the fourth potential commuting metric to determine a sixth comparison result; and
generating ranking data for each respective comparison result,
the generating the electronic file includes writing the ranking data to the electronic file.

19. The non-transitory, processor-readable medium of claim 15, further comprising instructions for:
receiving an activation signal that includes an instruction to determine the plurality of values of the commuting metric.

20. The non-transitory, processor-readable medium of claim 19, wherein the activation signal includes a data source change indicator, the data source change indicator identifying at least one of location data that has changed and commuter data that has changed.

21. The non-transitory, processor-readable medium of claim 15, further comprising instructions for:
sending, via the network communications interface, the electronic file, wherein the electronic file being generated in a markup language format.
